(19) United States
(12) Patent Application Publication
(10) Pub. No.: US 2006/0153272 A1
(43) Pub. Date: Jul. 13, 2006

(54) Ear thermometer

(76) Inventors: Kun-Sung Chen, San-Chung (TW); Ying-Chao Lin, San-Chung (TW); Hsing Ouyang, San-Chung (TW); Yao Ouyang, San-Chung (TW); Chun-Nan Chen, San-Chung (TW); Ching-Chin Shiao, San-Chung (TW); Hung-Chang Huang, San-Chung (TW); Chen-Lin Chiu, San-Chung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/032,130

(22) Filed: Jan. 11, 2005

(51) Int. Cl. G01J 5/00

(52) U.S. Cl. 374/121

(57) ABSTRACT

An ear thermometer has a main body and a probe projected from the main body. The ear thermometer has a casing, a sensor module and a tube. The casing has an opening formed in a front side thereof. The sensor module is installed inside the casing, and has a diameter of between 3.2 mm and 5.6 mm. The tube is installed between the casing and the sensor module for positioning the sensor module inside the casing. The diameter of the probe is reduced for insertion into an external ear canal of a human, and especially that of a baby, to measure true temperature.

### BACKGROUND OF THE INVENTION

1. Field of the Invention

The present invention relates to an ear thermometer, and particularly relates to an ear thermometer having a reduced probe for insertion into an external ear canal of a human, and especially that of a baby, to measure true temperature.

2. Description of the Related Art

A contact thermometer of the prior art such as a mercury-in-glass thermometer or an electronic thermometer cannot satisfy requirements of users. Hence a new thermometer and a measuring method thereof need to be developed to allow a user to measure and read temperature easily and accurately, that cannot easily harm the user and is ergonomic. Presently, an infrared non-contact thermometer with the above-mentioned advantage was developed.

Referring to FIG. 1, the infrared ear thermometer of the prior art provides a probe 1 projected therefrom for insertion into an external ear canal of a human. The probe 1 includes a casing 11, a sensor module 12 installed in the casing 11, and a wave guiding tube (copper tube) 13 for conducting heat (IR) from the external ear canal or an eardrum of a human to the sensor module 12. The sensor module 12 is installed on a back of the wave guiding tube 13. The wave guiding tube 13 conducts the infrared to the sensor module 12 for measuring the temperature of a subject.

Referring to the FIG. 2, another infrared ear thermometer of the prior art was developed for improving the above-mentioned defects. The infrared ear thermometer provides a probe 2. The probe 2 includes a casing 21, and a sensor module 22 installed in the casing 21. The sensor module 22 is a dual-sensor composed of a thermistor and a thermopile (contains a plurality of thermocouples) for measuring the temperature of a subject. The sensor module 22 is installed in a place that can directly sense heat radiation (IR) of the subject to omit the wave guiding tube between the subject and the sensor module 22. Moreover, the probe 2 further includes a heat insulation portion 23 installed between the casing 21 and the sensor module 22 for preventing transmission of heat from the casing 21 to the sensor module 22. The heat insulation portion 23 is made of good heat conducting metal material to improve accuracy of the temperature measurement.

However, the sensor module of the probe has a smaller diameter with 5.6 mm. The sensor module, the casing and the heat insulation portion are all assembled together to form the probe with a larger diameter. Hence it is not comfortable for a user to use the infrared ear thermometer, especially for a baby with a smaller external ear canal.

### SUMMARY OF THE INVENTION

The present invention provides an ear thermometer. The ear thermometer has a reduced probe for insertion into an external ear canal of a human, and especially that of a baby, to measure true temperature.

One aspect of the invention is an ear thermometer. The ear thermometer has a main body and a probe projected from the main body. The ear thermometer includes a casing, a sensor module and a tube. The casing has an opening formed in a front side thereof. The sensor module is installed inside the casing, and has a diameter of between 3.2 mm and 5.6 mm. The tube is installed between the casing and the sensor module for positioning the sensor module inside the casing.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objectives and advantages of the present invention will be more readily understood from the following detailed description when read in conjunction with the appended drawing, in which:

FIG. 1 is a cross-sectional view of a probe of an infrared ear thermometer according to the prior art;

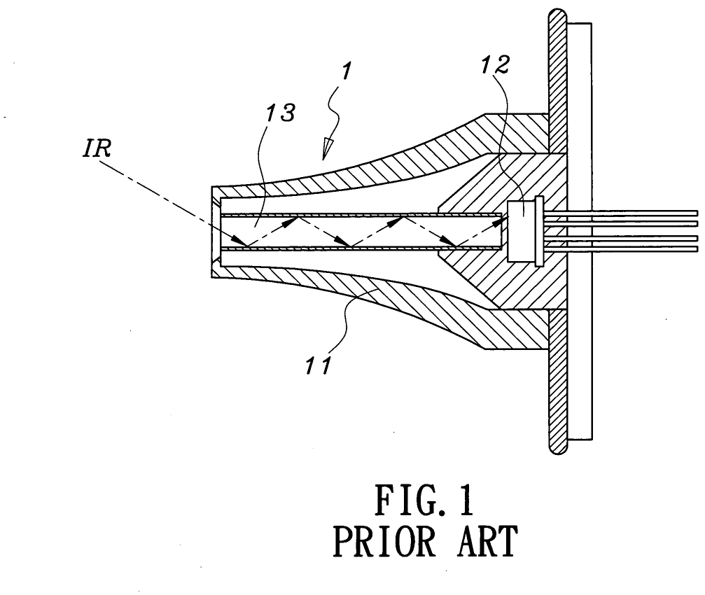

FIG. 2 is another cross-sectional view of a probe of an infrared ear thermometer according to the prior art;

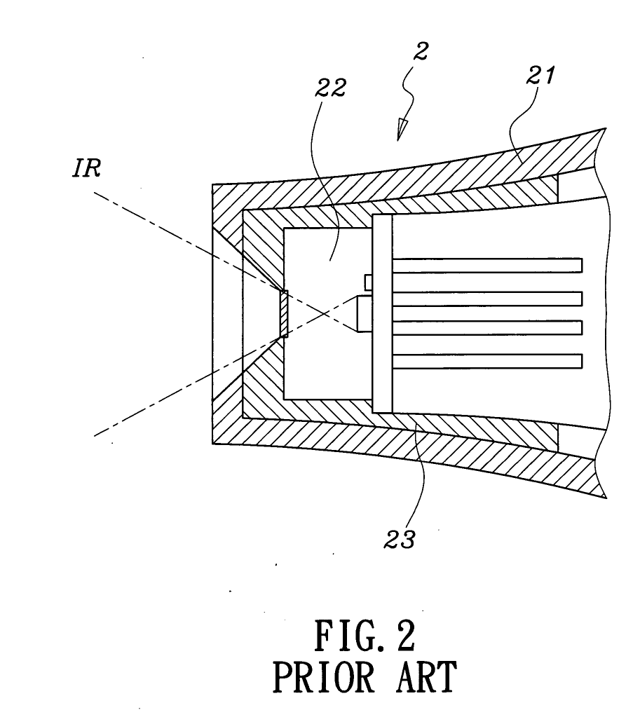

FIG. 3 is a cross-sectional view of a probe of an ear thermometer according to the present invention;

FIG. 4 is a partial magnified view of a probe of an ear thermometer according to the present invention; and

FIG. 5 is a perspective, exploded view of a probe of an ear thermometer according to the present invention.

### DETAILED DESCRIPTION OF PREFERRED EMBODIMENTS

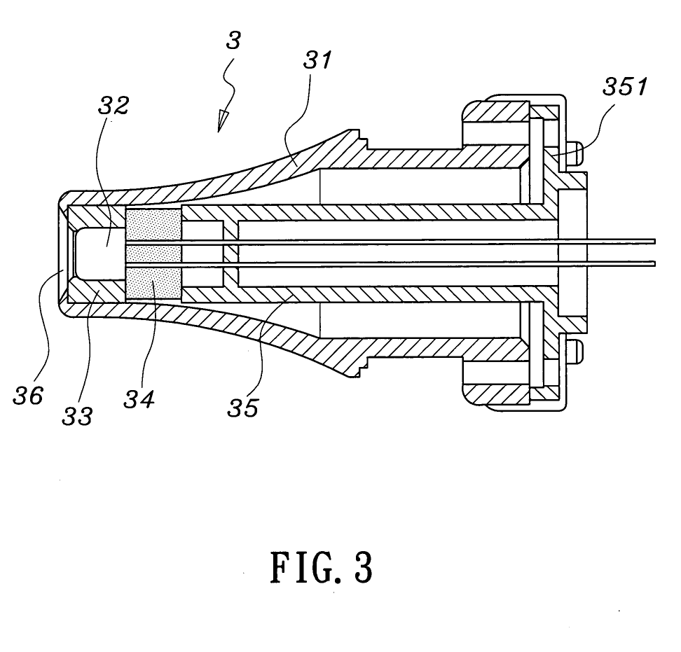

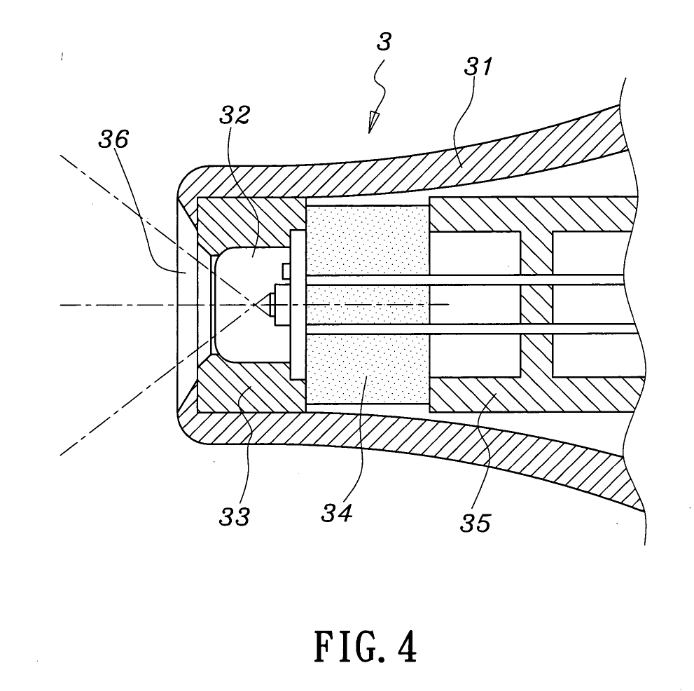

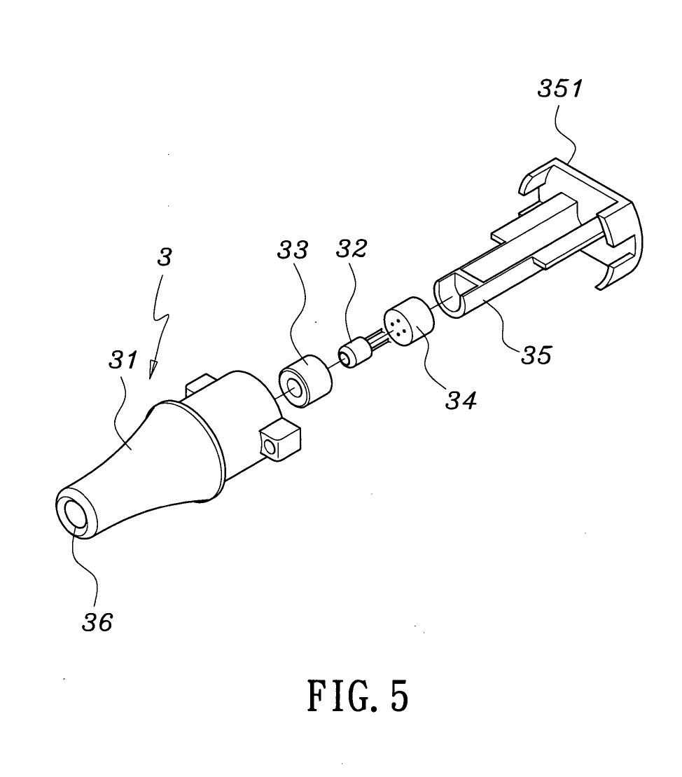

Referring to FIGS. 3 to 5, the present invention provides an ear thermometer. The ear thermometer includes a probe 3 projected from a main body (not shown) thereof for insertion into an external ear canal of a human.

The probe 3 is composed of a casing 31, a sensor module 32 and a tube 33. The casing 31 is a plastic hollow casing projected from the main body (not shown) of the ear thermometer. The casing 31 has an opening formed in a front side thereof.

The sensor module 32 is installed in the casing 31, and has a diameter of between 3.2 mm and 5.6 mm. The sensor module 32 has a thermistor and a thermopile composed of a plurality of thermocouples that connect together. The thermistor and the thermopile are assembled to form a dual-sensor. The thermistor is used to measure the temperature of a main body of the sensor module 32. The thermopile is used to measure the temperature difference between the subject and the sensor module 32. Hence the true temperature of the subject is measured. The sensor module 32 is installed in a place that can directly sense heat radiation of the subject and thus the wave guiding tube between the subject and the sensor module 32 can be omitted.

The tube 33 is made of plastic material such as rubber or silica gel. The tube 33 covers an external portion of the sensor module 32, and is installed between the sensor module 32 and the casing 31. The tube 33 with an elastic function is used to position the sensor module 32 in the casing 31. Moreover the tube 33 is waterproof. The probe 3 has an opening portion 36 formed in a front side thereof for receiving the infrared radiation in a predetermined range.

Furthermore, the probe 3 has a first support 34 and a second support 35 installed in the casing 31. The first support 34 and the second support 35 are fixed in the casing 31. The first support 34 has a front side that abuts against and presses upon a rear side of the tube 33 for positioning the waterproof tube 33. The second support 35 is installed on a back of the first support 34, and has a fixed portion 351 formed at a rear side thereof for fixing inside the casing to abut against the first support to abut against the tube. Hence, the tube 33 has a positioning function and a waterproof function.

The present invention provides the ear thermometer without the heat insulation portion, and only needs a tube 33 with a positioning and a waterproof function. Moreover, the probe 3 has an opening 36 formed in a front side thereof for receiving the infrared radiation in a predetermined range that does not include any non-subject. Hence, the sensor module is used to measure true radiation heat from a subject, and the sensor module is prevented from measuring temperature of any object other than the subject.

The sensor module 32 has a diameter of between 3.2 mm and 5.6 mm. Hence the diameter of the probe is reduced for insertion into an external ear canal of a human, and especially that of a baby, to measure true temperature.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An ear thermometer having a main body and a probe projected from the main body, the ear thermometer comprising:
a casing having an opening formed in a front side thereof;
a sensor module installed inside the casing, and having a diameter of between about 3.2 mm and 5.6 mm; and
a tube installed between the casing and the sensor module for positioning the sensor module inside the casing.

2. The ear thermometer as claimed in claim 1, wherein the tube is made of rubber material.

3. The ear thermometer as claimed in claim 1, wherein the tube is made of silica gel material.

4. The ear thermometer as claimed in claim 1, wherein the probe has a first support installed in the casing for abutting against and pressing upon a rear side of the tube.

5. The ear thermometer as claimed in claim 4, wherein the probe has a second support fixed inside the casing for abutting against the first support to abut against the tube.
